(19) United States
(12) Patent Application Publication
(10) Pub. No.: US 2017/0193462 A1
(43) Pub. Date: Jul. 6, 2017

(54) FINANCIAL SWITCHING ENGINE AND MESSAGING

(71) Applicant: EURONET USA LLC, Little Rock, AR (US)

(72) Inventor: Martin BRUCKNER, Martinsried (DE)

(21) Appl. No.: 15/313,054

(22) PCT Filed: May 21, 2015
(86) PCT No.: PCT/EP2015/061321

§ 371 Date: Nov. 21, 2016

(30) Foreign Application Priority Data
May 21, 2014 (GB) 1409050.0

(51) Int. Cl. G06Q 20/02

(52) U.S. Cl. CPC G06Q 20/027

(57) ABSTRACT

A method comprising communicating at least one message in a financial transaction system comprising at least one end-user device, at least one financial-provider entity, and a financial switching engine located between said at least one financial-provider entity and said at least one end-user device, said financial switching engine arranged to perform a switching operation to switch the message between said at least one end-user device and said at least one financial provider entity; wherein said message is for facilitating a financial transaction in said financial transaction system, and wherein said at least one message is adapted to be of an extensible format and configured to comprise a plurality of tags, wherein said tags comprise information facilitating said switching operation and additional operator-defined content; and wherein said method comprises processing said information at at least one of said end-user device, said financial-provider entity and said financial switching engine for processing of said financial transaction.

### TECHNICAL FIELD

The present disclosure relates to the field of financial transaction messaging.

### BACKGROUND

It is known to provide a financial transaction system for performing financial transactions between various elements, e.g. to route a transaction initiated from an automatic teller machine (ATM) or point-of-sale (PoS) terminal to the settlement system of a financial service provider, or to top-up a prepaid account such as a prepaid phone-time account from an ATM or PoS terminal. The system includes a financial switching engine which receives transaction messages from one element of the system, and comprises a set of rules for directing them to another. The switching engine receives a message, examines its content, and applies the rules to the content in order to makes a decision about where to forward the message.

The financial transaction system can also include other functions associated with the performance of financial transactions, e.g. for checking an account balance or generating other reports, logging transactions in a database, or monitoring an account to generate alerts. Euronet application WO 02/13120 discloses a system comprising a plurality of interchangeable, standard-interface, modular financial service applications, each providing a different respective financial service, e.g. one for account access, one for account management, one for transaction management and one for event messaging.

In existing transaction systems, the system including the switch and other financial functions are implemented together at a central data centre connecting outwards to its various endpoints (e.g. ATMs, PoS systems, and/or financial provider settlement systems) via one or more data networks. The data centre may be arranged as a central element mediating between a plurality of different financial networks (e.g. one or more ATM networks, PoS network and/or financial provider networks). There may also be provided a back-up data centre in case of failure of the main data centre.

### SUMMARY

The existing approach utilises messaging formats of a fixed type for communicating transaction information between entities within a system architecture. The messaging format is inflexible and cannot be changed to account for new information which may be required over time.

In a first aspect there is provided a method comprising: communicating at least one message in a financial transaction system comprising at least one end-user device, at least one financial-provider entity, and a financial switching engine located between said at least one financial-provider entity and said at least one end-user device, said financial switching engine arranged to perform a switching operation to switch the message between said at least one end-user device and said at least one financial provider entity; wherein said message is for facilitating a financial transaction in said financial transaction system, and wherein said at least one message is adapted to be of an extensible format and configured to comprise a plurality of tags, wherein said tags comprise information facilitating said switching operation and additional operator-defined content; and wherein said method comprises processing said information at at least one of said end-user device, said financial-provider entity and said financial switching engine for processing of said financial transaction.

Preferably said method comprises configuring at least one of said financial-provider entity, said at least one end-user device and said financial switching engine to define said operator-defined content.

Preferably said financial transaction system comprises at least one plug-in.

Preferably said method comprises attaching said plug-in to said system.

Preferably an operator of said plug-in is configured to define said operator-defined content.

Preferably one or more of said plurality of tags contain information for enabling said switching operation, and one or more other tags of said plurality of tags comprise said operator-defined content.

Preferably said information in each of said tags comprises at least one of: security information; monetary value information; end-user identity information; fingerprint information; photograph information; location information.

Preferably said at least one message comprises a header and a message body, said plurality of tags being comprised in said message body.

Preferably said method further comprises establishing a private network for said financial transaction system.

Preferably said operator-defined content provides functionality of a type not previously utilised in said system.

Preferably said end-user device comprises at least one of a point-of-sales terminal and an automatic teller machine.

Preferably said at least one financial-provider entity comprises at least one of Visa and Mastercard.

Preferably said additional operator-defined content is used for a purpose other than said switching operation.

In a second aspect there is provided a computer program comprising computer executable instructions which when run on one or more processors performs the method of the first aspect.

In a third aspect there is provided a system comprising: at least one end-user device; at least one financial-provider entity; a financial switching engine located between said at least one financial-provider entity and said at least one end-user device; said financial switching engine arranged to perform a switching operation to switch the message between said at least one end-user device and said at least one financial provider entity; wherein said at least one end-user device, said at least one-financial provider entity and said financial switching engine are configured to communicate at least one message for facilitating a financial transaction in said financial transaction system, wherein said at least one message is adapted to be of an extensible format and configured to comprise a plurality of tags, wherein said tags comprise information facilitating said switching operation and additional operator-defined content; and wherein at least one of said end-user device, said financial-provider entity and said financial switching engine is configured to process said information in said plurality of tags for processing of said financial transaction.

Preferably at least one of said financial-provider entity, said at least one end-user device and said financial switching engine is configured to define said operator-defined content.

Preferably said financial transaction system comprises at least one plug-in.

Preferably an operator of said plug-in is configured to define said operator-defined content.

Preferably one or more of said plurality of tags contain information for enabling said switching operation, and one or more other tags of said plurality of tags comprise said operator-defined content.

Preferably said information in each of said tags comprises one or more of: security information; monetary value information; end-user identity information; fingerprint information; photograph information; location information.

Preferably said at least one message comprises a header and a message body, said plurality of tags being comprised in said message body.

Preferably said system is configured to establish a private network.

Preferably said operator-defined content provides functionality of a type not previously utilised in said system.

Preferably said end-user device comprises at least one of a point-of-sales terminal and an automatic teller machine.

Preferably said at least one financial-provider entity comprises at least one of Visa and Mastercard.

Preferably said additional operator-defined content is used for a purpose other than said switching operation.

### BRIEF DESCRIPTION OF THE DRAWINGS

To assist understanding of the following description and to show how embodiments may be put into effect, reference is made by way of example to the accompanying drawings in which:

FIG. 1 schematically illustrates centralised and distributed approaches to implementing a financial transaction system,

FIG. 2 schematically illustrates a high-level architecture of a financial transaction system,

FIG. 3 schematically illustrates a distributed implementation of a financial transaction system, and

FIG. 4 schematically illustrates a transaction formed from a plurality of plugin instances.

FIG. 5 is an example of an ASN.1 X.509 BER SSL certificate.

### DETAILED DESCRIPTION OF EMBODIMENTS

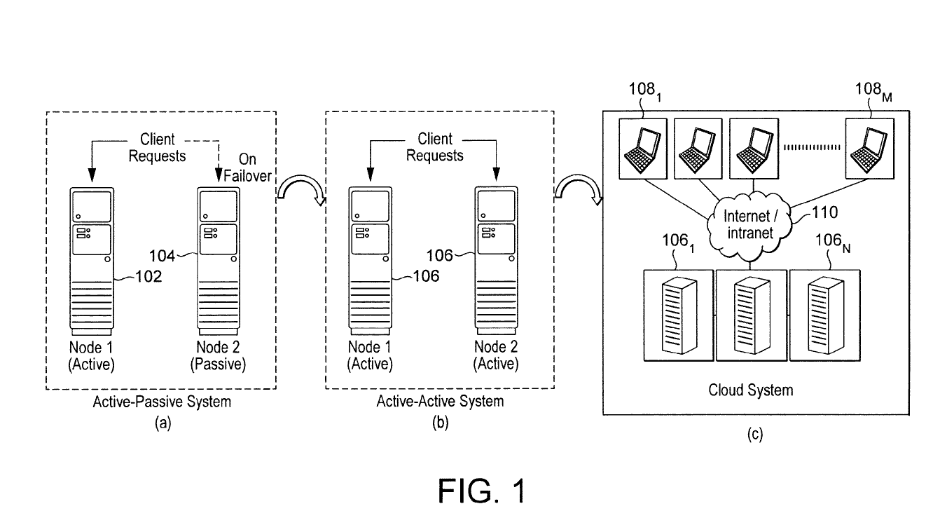

FIG. 1 illustrates the concept of an active-active approach relative to a passive-active approach, and the extension of the active-active idea to a fully distributed, cloud based approach in a financial transaction system.

An existing approach may be described as an “active-passive” approach in that at any one time, only one data centre of a plurality of data centres is active. In normal operation the main data centre is active while the back-up data centre is dormant; and in case of failure of the main data centre, the back-up data centre is active while the main data centre is not functioning.

In an “active-active” approach different data centres are active at any one time. Furthermore, this idea may be extended to a distributed, cloud-based approach where multiple different modular plugin applications are distributed amongst a plurality of different data centres over a plurality of different physical locations.

FIG. 1(a) shows an active-passive implementation comprising a main data centre 102 and a back-up data centre 104. When a client request is received from a service endpoint terminal (e.g. PoS terminal or ATM), the request message is routed to the main data centre 102 to be processed. Assuming the main data centre 102 is operative then all such client request messages are routed only to the main data centre 102. Only in case of failure such that the main data centre is not operative, request messages are instead routed to the back-up data centre 104 to be processed. Hence at any one time only one of the data centres 102, 104 is active.

FIG. 1(b) illustrates the idea of an active-active implementation comprising two (or more) data centres 106, neither of which need necessarily be considered the “main” data centre. When a client request is received from a service endpoint terminal (e.g. PoS terminal or ATM), it may be routed to either of the data centres 106 to be processed depending on the request. Thus some client request messages are routed to one data centre 106 and other such message are routed to the other data centre 106, with both data centres being active processing different requests at substantially the same time.

FIG. 1(c) shows an extension of the active-active approach to a cloud system in accordance with embodiments disclosed herein. The system comprises a plurality of physical data centres 106 distributed over a plurality of physical locations, e.g. different buildings, different sites, different towns or cities, or even different countries. The different physical data centres 106 may each be associated with multiple servers and/or devices. The different physical data centres 106 are connected together via a private network 110. The private network 110 may be implemented by means of a private physical network infrastructure, or by means of a private (secure) network protocol implemented over a public physical network infrastructure such as the Internet, or by a combination of these. A plurality of service endpoint terminals 108 (e.g. PoS terminals and/or ATMs) are also connected to the private network 110, and are thus operable to communicate with any of the distributed data centres 106 via the private network. At any given time, any two, more or all of the different distributed data centres 106 may be active and processing transactions in parallel. When a service request message is sent from a service end-point 108 it may be directed to any one or more of the data centres depending on factors such as the nature of the request, the current load on the system and the cost of routing the message. In the cloud approach a plurality of physical processing centres can be represented by a logical processing centre. In an embodiment many physical processing centres can be represented by a single, large logical processing centre. In other words in some embodiments the physical processing centres 106 are comprised in a “cloud” which a customer can connect to using endpoint terminals 108 via the internet/intranet 110, which may be a private network.

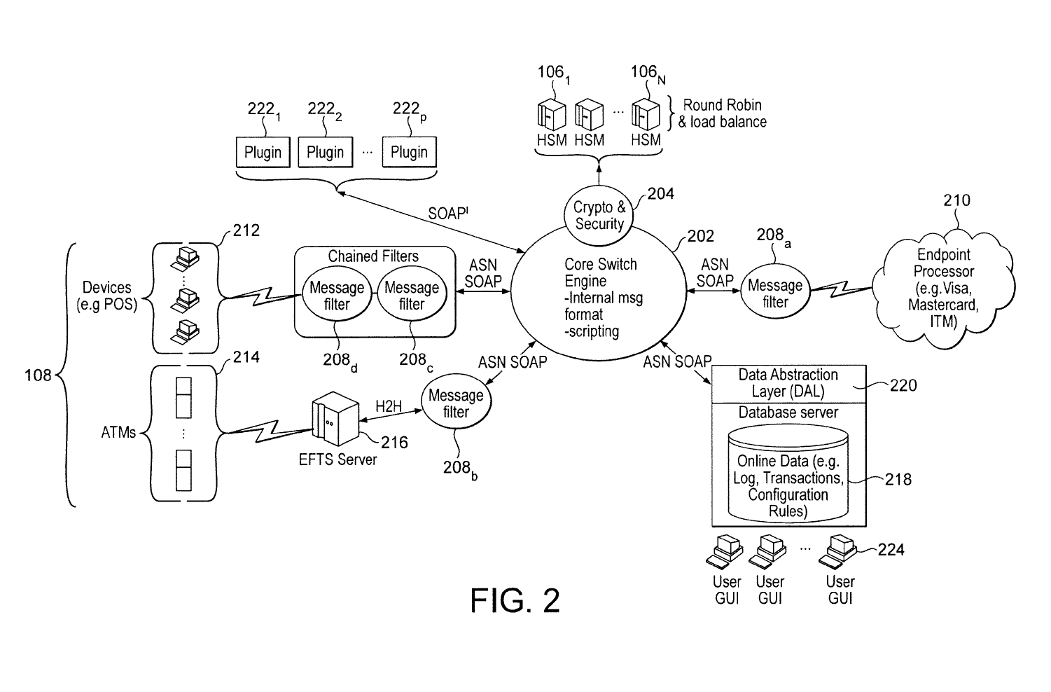

FIG. 2 shows the architecture of a financial transaction system within which some embodiments may operate. A function of the system is to provide a financial switching engine, acting as an intermediary between a plurality of service end-point terminals 108 (which may be user terminals or end-user devices) and one or more financial providers 210 (the systems at the other endpoint of the transaction where the transaction is ultimately processed). To this end the system comprises a financial switching engine 202 (the core switch) and a plurality of message filters 208 which act as interfaces or device handlers. The system also comprises a plurality of additional elements which can be involved in the transactions. In FIG. 2, these comprise for example at least one security module 204, and a data abstraction layer (DAL) 220 for interfacing with a database 218.

The service endpoint terminals 108 may comprise for example one or more point-of-sale (PoS) terminals 212, and/or one or more automatic teller machines (ATMs). The financial provider systems 210 may comprise for example the settlement systems of one or more credit or debit card providers, an online banking system, and/or the prepaid account system of one or more providers of prepaid goods or services. The financial switching engine 202 is connected to the service endpoint terminals 108 via one or more message filters 208, e.g. being connected to each type of service endpoint terminal 212, 214 via at least one respective message filter, and via any respective infrastructure of the endpoints 108. For example in FIG. 2 the financial switching engine 202 may be connected to the ATMs 214 via one or more message filters 208b and an ATM network comprising an EFTS (electronic funds transfer server) 216, and may be connected to the PoS terminals 212 via one or more message filters 208c, 208d and a point-of-sale network (not shown). The financial switching engine 202 is also connected to the one or more provider systems 210 via one or more message filters 208, e.g. being connected to each provider 210 via at least one respective filter 208a.

The financial switching engine 202 is thus disposed between the service end-point terminals 108 and the provider systems 210. The financial switching engine 202 is configured to receive messages, examine their content and based thereon switch them onwards to the appropriate element of the system according to a set of switching rules. For example this may comprise receiving a service request message from a service endpoint device 108 via the respective filter(s) 208b, 208c, 208d, then reading at least enough of the message to determine the nature of the request and forwarding via another filter 208a to the appropriate provider 210 for processing, as well as potentially forwarding the message or information about it to the database 218 via the DAL 220 to be logged. As another example (e.g. as a complementary part of the same transaction) the switching performed by the financial switching engine 202 may comprise receiving a report message from a provider 210 (e.g. in response to the request) via the respective filter 208a, reading enough of the message to determine its nature as a report, and forwarding to the relevant endpoint terminal 108 via the respective filter(s) 208b, 208c, 208d. Again this may also comprise a step of sending the report or information about it to the database 218 vial DAL 220 for logging.

Filters 208 are components which perform specialized units of work (e.g. TCP/IP communication, device handlers, MasterCard online messages, etc.). In embodiments filters 208 are components which are not included within the core financial switching engine 202. They may comprise specialized processes such as device handlers (e.g. ATM, POS), network handlers (e.g., MasterCard, Visa, etc.), and other function-specific processes. Filters 202 and other non-core components may “pre-decline” a transaction, but may still be required to route into the core 202 for logging and subsequent routing. The core switching engine 202 may detect pre-declined messages and drop into a “declined decision tree” and potentially override pre-declined values.

In embodiments there may be different filter types: standalone filters, chained filters and embedded filters. The standalone type of filter handles a complete unit of work (e.g. MasterCard filter, etc.). Chained filters may be linked in sequence where each filter completes its unit of work and passes the results to the next filter. As for embedded filters, this concept allows a filter to be embedded within another filter so the “master” filter effectively appears to be a standalone filter. However, the master filter may in fact comprise an accumulation of other filters. Likewise, a filter embedded within a master filter may also function as a standalone filter.

The filter concept can be used to support a centralized and/or generic network filter as well as network-specific filters which handle unique network requirements (e.g., MasterCard, Visa, etc.). For example the filters 208 may comprise filters for online transaction processing, network-specific online filters, filters for network clearing processing, and/or network-specific clearing filters.

For instance for online transaction processing, a generic network filter may handle the Interface layer between the core financial switching engine 202 and the network-specific online filters, while network-specific online filters handle each network's unique messaging requirements and provide the interface layer between the generic network filter and the individual networks.

Regarding the network clearing processing, a separate network clearing process is typically used by a provider network, including the incoming/outgoing file processing logic and the clearing user interface. In embodiments however, there may be provided central clearings application, in which case the new architecture is arranged to create a generic clearing application which handles incoming/outgoing files and the clearing user interface. This is implemented by identifying the common clearing functions between all networks so the central clearings application may be designed to accommodate those needs in a generic manner. In order to facilitate the network-specific clearing requirements, the network-specific clearing filter layer will provide a layer between the central clearings application and the networks. These filters will perform network-specific reformatting between network supplied files and files handled by the central clearings application. In embodiments, these filters will accept and send data from and to the central clearings application in a standardized format. The filters will reformat data according to network and the standard messaging format.

In embodiments these filters may comprise filters specific to particular providers, e.g. MasterCard, Visa, American Express. For example MasterCard-specific filter(s) may comprise: filters specific to managing MasterCard clearing processes, a MasterCard Messaging filter and/or a MasterCard administration filter. The MasterCard Messaging filter is responsible for MasterCard-specific message handling and reformatting, and in embodiments also routing to the downstream MasterCard communication filter. The messaging filter might also monitor the downstream MasterCard communication filters at a high level to identify/report issues and node connection issues. The MasterCard administration filter handles MasterCard MIP connections, administrative messaging, and/or flexible message matching to identify response thread.

In embodiments the filters 208 may further comprise communications filter(s) for performing operation of: retrieving Incoming messages from the communication line, splitting multiple messages into individual messages, handling cases where messages are split across packets, directing raw messages into the appropriate filter(s) and/or core 202, placing response messages on the communication line, maintaining a persistent connection, and/or keeping track of message-level “thread thumbprints” which indicate which thread sent the request so the communication filter is able to return responses to the correct thread. The filters 208 may further comprise ISO-8583 message filters such as: generic ISO-8583 message filter similar to the ITM Super DCM concept, Host-to-Host Interface filter(s) and/or H2H to EFTS.

The filter(s) 208a thus provide an interface with the settlement system(s) of one or more financial provider systems for performing online transaction processing and/or debit or credit card transactions. Further, as mentioned the filters 208b, 208c, 208d may comprise device handler modules for interfacing with the PoS terminals 212, ATMs 214 via their associated infrastructure. Further, there may be provided filters 208 for topping-up or redeeming prepaid account credit, by interfacing to a financial institution and a prepaid account system of the provider of the prepaid good(s) or service(s), e.g. an account of prepaid phone minutes. The financial switching engine 202 sits in the middle connected between these service endpoints 108, 212, 214, provider system(s) 210, and prepaid account(s) (not shown) via the respective filter(s) 208, and is arranged to switch messages between them as appropriate to the message in question.

The system of FIG. 2 further comprises one or more operator user terminals 224 (distinct from service endpoints 108, 212, 214) which are connected to the database 218. These provide a user interface enabling an operator of the system to access records of transactions that have been logged via the DAL 220 and switching engine 202, as well as setting any configurations or rules of the system that the system enables the operator to control. In embodiments the user interface may provide a broad number of user interfaces such as: system configuration, system management, system health monitoring, network clearing, audit and/or research.

As further illustrated in FIG. 2, the system comprises a security sub-system in the form of one or more security modules 204 for handling the cryptography involved in the transactions being performed, as well as any other security measures. This may comprise a hardware security module (HSM) providing tamperproof management of security keys. Any transactions that involve messages being conveyed between different physical data centres 106, and over any external connections to or from any of the service endpoint terminals 108 and provider systems 210, will be encrypted for security using a security key. The security module 204 performs the necessary encryption and decryption as required by the switching engine for reading and/or transmitting messages.

As mentioned previously, the functionality of the system is implemented in the form of a plurality of plugins 222. The plugins 222 comprise units of software and are modular in nature, giving the ability to be enhanced with unique and/or custom features demanded by clients. Likewise, they support the ability to augment existing functionality without changing other elements. In embodiments everything is implemented as a plugin 222, even the core financial switching engine 202 and HSM.

Hence in embodiments the plugins 222 may comprise: a plugin implementing the core financial switching engine 202, one or more plugins implementing the functionality of the one or more security modules 204 (e.g. comprising the software of the HSMs), one or more service endpoint interface plugins for interfacing with the service endpoint terminals 108 (via any associated infrastructure such as a PoS network or EFTS server), and one or more transaction processing plugins e.g. for interfacing with the provider system(s) 210. The service endpoint interface plugins may comprise a PoS plugin for interfacing with the PoS terminals 212 via the PoS network, and/or an ATM plugin for interfacing with the ATMs 214 via the ATM network (comprising the EFTS server 216). The transaction processing plugins are configured to process financial transactions by interfacing to the relevant provider system 210. The plugins may also comprise plugins for online transactions and/or prepaid account transactions. Hence the plugins 222 may implement some or all of the functionality of said filters 208.

In embodiments the DAL 220 may also be implemented as one of said plugins 222. The system may comprise one or more other plugins 222 (not shown) such as: a transaction logging plugin for logging transactions in the database 218 via the DAL 220, a reporting plugin for generating reports relating to the transactions (e.g. reporting on account activity), a protocol conversion plugin for converting between different communication protocols used throughout the system, and/or a transaction lifecycle plugin for managing the lifecycle of a transaction.

Further plugins 222 may also be added to bring new functionality to the system at any time. For example, if the financial provider 210 has a new security feature or other functionality that they wish to introduce to the system, then this can be done by way of a plugin. Likewise, any other entity in the system can also introduce new functionality by means of one or more plugins.

A plugin 222 may also act as a stand-alone entity within the system, rather than simply acting as an extension of an existing entity.

The plugins 222 can be chained together to create transactions, as will be discussed in more detail shortly.

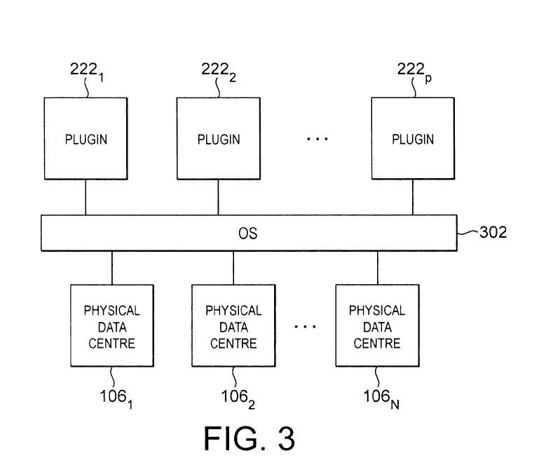

FIG. 3 now illustrates the actual physical implementation of the system, and particularly its distributed nature. The system comprises a plurality of plugins 222 (such as those discussed above) distributed amongst a plurality of physical data centres 106. The physical data centres are implemented at a plurality of different respective physical sites, e.g. different buildings, different towns or even different countries. In embodiments there may be at least three data centres, or at least ten, or multiple tens of data centres, or even over a hundred upwards. As mentioned, the data centres 106 are connected together via a private network 110, which may comprise a private network infrastructure and/or a private protocol implemented over a public network such as the Internet (sometimes called a virtual private network).

Where it is said that the plugins 222 are distributed amongst different data centres 106, this may mean one or both of two things: firstly, it may mean that different types of plugin are implemented at different data centres (e.g. the core 202 at one data centre 106 and the ATM interface 208b at another, etc.); and/or secondly, it may mean that different instances of a given plugin may be implemented in parallel at different data centres (e.g. so instances of the core 202 may be implemented at multiple data centres 106, and instances of the ATM interface 208b may be implemented at multiple data centres 106, etc.). I.e. each plugin 222 is physically stored and/or executed on one or more of the data centres 106, with different plugins 222 at least in part being stored and/or executed on different data centres, or even each plugin distributed amongst all the data centres 106. Note also that multiple instances of a given plugin 222 may also run in parallel on a given data centre 106. Instances herein can refer to different copies of the same (or substantially equivalent) plugin 222 stored at different data centres 106, or different instances of the same copy running at a given data centre (i.e. the same copy operating on different transactions in parallel).

In between the plugins 222 and physical data centres 106 there is provided an operating system 302 which is configured to abstract the plugins 222 from the underlying, physical, distributed nature of the data centres 106. This means the plugins 222 do not have, and nor do they need, any visibility of the distributed structure of the physical implementation of the system. If a given plugin 222 is to send a message destined for another plugin 222, it issues the message only to the operating system and does not specify the physical address of any data centre 106 (and nor does it have any need to do so). The physical routing of messages between the data centres 106 running the source and destination plugins 222 (or source and destination instance of the plugins) is handled by the operating system 302 without either plugin 222 needing to know about it—instead the plugin just sends the message to another plugin via the OS, without the plugins 222 needing knowledge of the different distributed data centres 106. Thus the plugins 222 handle the business logic while the operating system handles the underlying physical routing over the network 110.

The operating system 302 itself may be implemented in a distributed fashion amongst some or all of the data centres. This may comprise implementing a plugin look-up table mapping the plugins or instances of the plugins to data centres and/or recording which plugins are available, with the look-up table being distributed amongst some or all of the data centres. Alternatively the look-up could be implemented centrally. Either way, when it receives a message from a plugin 222, the operating system 302 can thus look up the actual physical destination which the message should be routed to for processing.

The operating system 302 may also be configured to perform load balancing to try to optimally balance the load of storing and/or executing the different plugins 222 or instances of the plugins 222 amongst the different data centres 106, so that no one data centre 106 bears an undue burden of the memory and/or processing resources being consumed by the system overall. The load balancing mechanism considers parameters such as: internal resources of a data centre 106 like CPU usage and memory, and external resources like TCP connection, database connection, and network latency. A run-time increase or decrease in the number of plugin instances is possible if required, and this can be performed manually or automatically. The inbuilt intelligent load balancing can operate even without a manual configuration change, but in embodiments explicit hints can be made by the operator such as: configuration queue threshold, configuring priority, configuring response time-out, configuring throughput time, and/or configuring memory consumption threshold. The load balancing may be considered a form of intelligent message routing.

Further, the operating system may be configured to perform a best-cost routing to find the best route for the messages of a transaction amongst data centres 106 over the network 110. This intelligent dispatching provides an automatic calculation of the optimal routing cost based on path latency, message queue size, processing speed, priority, plugin availability, and/or plugin response (e.g. a plugin can define its own node as a defect). The above attributes can be manually controlled by a configuration change, or automatically. Preferably the operating system is configured to be able to interpret different scripting languages such as Java, LUA and/or C++ (used as a scripting language), and is thus configured to support plugins 222 programmed in such different languages. Preferably the system is also configured to support different communication protocols for communicating between different ones of the plugins 222 and/or between the core switching engine 202 and plugins 222. For example the communication protocols may comprise SOAP, REST, ASN.1 and/or an H2H protocol. In embodiments, the protocol conversion may be implemented by one or more of the plugins 222.

Further, the system is preferably database agnostic in that it comprises the data abstraction layer (DAL) 220, which supports multiple database types, e.g. SQL, MySQL, PostGreSQL, MS-SQL, DB2 and/or Oracle. In embodiments the DAL 220 may or may not be one of said plugins. In embodiments the database may be distributed amongst some or all of the data centres, or may be implemented centrally.

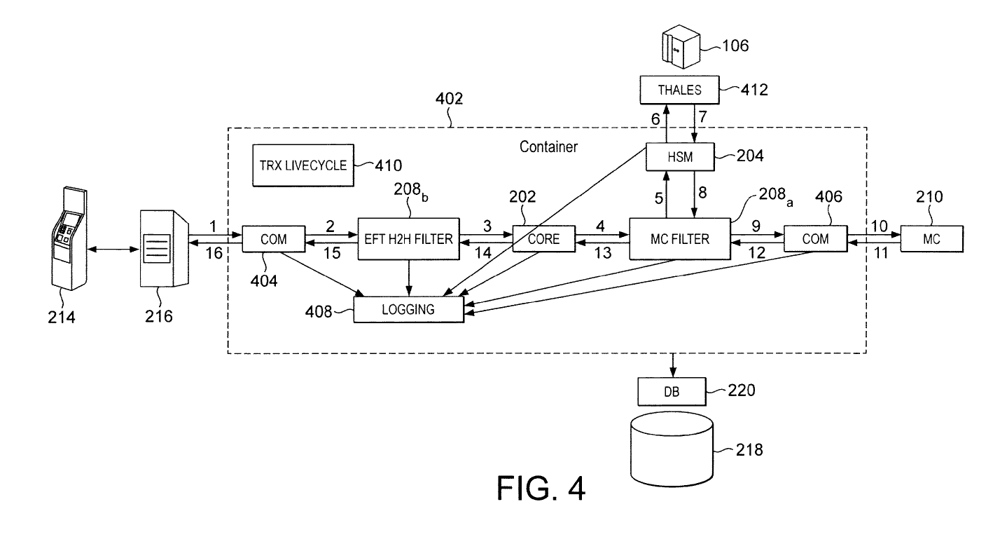

FIG. 4 illustrates an example of a plurality of plugins 222 being chained together to form a transaction, in this case a credit or debit card transaction between an ATM 214 and a credit or debit card provider 210. The transaction is formed using: an instance of a transaction lifecycle plugin 410, an instance of the core financial switching engine plugin 202, an instance of a security plugin 204, and instance of a logging plugin 408, instances of two service endpoint plugins in the form of a communication plugin 404 and an EFT H2H filter plugin 222, and instances of two transaction processing plugins in the form of a credit or debit card filter 208a and a communications filter 406. Plugins are loaded dynamically on a per connection basis. In embodiments the instances of the plugins 222 for a given transaction are brought together and managed over its lifecycle by the transaction lifecycle plugin 410.

The ATM 214 may issue a request message to the switching core 202 via the EFTS 216 and service endpoint plugins 404, 208a. The switching engine 202 examines the message to determine that it is a request for a credit or debit card transaction and thus determines that it is to be directed to the system 210 of the credit or debit card provider for settlement. Accordingly, the switching engine 202 forwards the message to the credit or debit card settlement system 210 via the provider interface plugins 208a and 406. Once the transaction is thus settled (or declined) by the card provider system 210, it returns a response to the ATM 214 via the switch 202, interfaces 406, 208a, 208b, 4040 and ETFS 216. Each of one or more stages of the transaction may also be logged in the database 218 by the logging plugin 408, via the DAL 220. The security plugin 204 handles the encryption of the messages so that any message communicated between physical data centres 106 are duly encrypted, via the hardware 412 of an HSM.

A messaging format for communication within the financial transaction system will now be discussed in more detail. The proposed messaging format is extensible to provide additional flexibility to the system by enabling new or additional types of information to be included in messages. A message according to the messaging format is usable by the financial switching engine 202 for facilitating switching of messages between the end-point terminals 108 and the financial provider 210. In addition to facilitating the switching functionality, the messaging format may include further information for purposes other than the switching operation. For example the messaging format may include information that is useful to the end-point terminals 108 or the financial provider 210 (or indeed any other entity in the system), which information is not necessarily required to enable the switching. Therefore in embodiments the messaging format is dual purpose: it facilitates the switching operation and provides other useful information. That is the message format which is used for facilitating the switching operation is also used for an extensible purpose.

The message format includes a “header” and a “body”. The message header contains address information, for example the destination address of the message to enable the message to be successfully routed through the system. The message body contains the actual data to be sent i.e. the payload of the message.

In embodiments the message format is extensible such that new data elements can be included in the messaging format without major (or any) programming or structural changes to the system. The extensible format also enables the message to be tailored for specific needs or uses. The messaging format can therefore be altered to meet future demands without fundamental architectural changes.

In an embodiment, the Abstract Syntax Notation 1 (ASN.1) format is utilised for the messaging protocol. ASN.1 is a standard and flexible notation that describes rules and structures for representing, encoding, transmitting, and decoding data in telecommunications and computer networking. The formal rules enable representation of objects that are independent of machine specific encoding techniques. The standard ASN.1 encoding rules include: basic encoding rules (BER); canonical encoding rules (CER); distinguished encoding rules (DER); XML encoding rules (XER); packed encoding rules (PER); and generic string encoding rules (GSER). In some embodiments the BER standard is used, which enables an ASN.1 value to be represented as an octet stream.

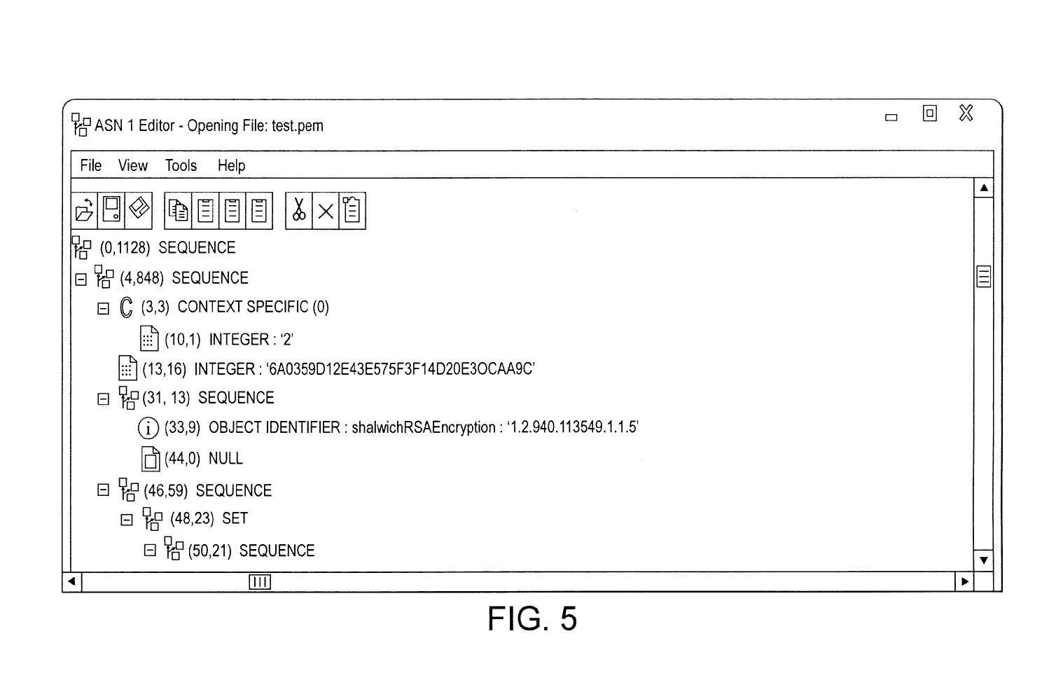

FIG. 5 shows an example of an ASN.1 X.509 BER SSL certificate.

Below is an example of LUA script used to control the routing, message flow, C++ object according to an embodiment where a transaction is being made by a mobile phone. Within this script is shown a step of identifying an issuer participant and destination plugin. Also, the script may perform reversal of a previous transaction, subject to certain conditions being met:

local l_itmmObj = itmmObj --C++ Object access
local pan = l_itmmObj:getPAN ( ) --Accessing attribute of C++ objects
local acqPartId = l_itmmObj:getParticipantAcqID ( )
local msgType = l_itmmObj:getMsgType ( )
local issPartId, destination = l_itmmObj:doBinRouting (pan, acqPartId) --Identifying Issuer
Participant & destination plugin
-- Controling Multileg transactions workflow in Lua

| if | (msgType == MOB_RECHARGE) then --Mobile Recharge, MT:6 | |
|---|---|---|
| | local uuid = l_itmmObj:getMsgULAD ( ) | |
| | local legTnxNr, legTnxStatus, legTnxResult = l-itmmObj:getLegTnxStatus (uuid) | |
| | if | (legTnxStatus == 0) and (legTnxNr == 0) and (legRnxResult == 0) then --Need to |

execute 1^{st} Leg transaction

| | |
|---|---|
| | l_itmmObj:setIssuerPartId (issPartId) |
| | l_itmmObj:setDestination (destination) |
| else if | (legTnxNr == 1) and (legTnxStatus ==1) and (legTnxResult == 0) then --Need to |

execute 2^{nd} Leg transaction

| L_itmmObj:setIssuerPartId (MOB_OPERATOR_PARTICIPANT) | |
|---|---|
| l_itmmObj:setDestination (MOB_OPERATOR_PLUGIN) | |
| else | --Initiate Reversal of previous transaction |

l_itmmObj:setIssuerPartId (700000)
l_itmmObj:setDestination (ERROR)
end

end

| | |
|---|---|
| else | --Financial Transaction |

l_itmmObj:setIssuerPartId (issPartId)
L_itmmObj:setDestination (destination)

end

It will therefore be understood that the script can enable dynamic routing within the system.

In embodiments it is the message body i.e. the payload portion of the message that is ASN.1 encoded. In some embodiments the data payload does not include information regarding the specific request message type. Instead, individual filters format the ASN.1 data payload and wrap the data in a SOAP request which indicates the request type (e.g. transaction, MAC, cryptography, logging etc.). The internal ASN.1 based data payload consists of Object Identifier (OID) values specific to the request type.

In embodiments the message body includes one or more fields or “tags” with information enabling a transaction to take place. The information contained in these tags may be used at the core switching engine 202 to facilitate a switching operation of information between the end-point terminals 108 and the financial provider 210. That is such tags may include information which enables the core switching engine 202 to route the message through the system.

The message may also include fields or tags such as, by way of example only:

<Security information>
<Transaction value>
<Merchant ID>
<User ID>
<Location>

A transaction may contain one or more of these tags, dependent upon the application and the requirements of the endpoint processor at a given point in time (e.g. Visa, MasterCard etc). These requirements may vary over time.

As discussed above the message format is of an extensible type meaning that new tags can be introduced at any time without requiring significant (or any) changes to the system architecture. For example a card issuer (e.g. Visa or MasterCard) may decide that they require photo information to be included in the message format to improve security. This may be a photograph of a cardholder's face, for example. Accordingly a <photo> tag can be added to the message format. The financial provider 210 (or indeed any entity to which this functionality has been assigned) may be configured to compare the information in the <photo> tag with stored photograph information to determine whether there is a match. If there is a match then the financial provider 210 may allow the financial transaction to proceed.

The stored photograph information (with which the <photo> tag is compared) may be stored within an entity such as the financial provider 210 itself, or in a database accessible thereto.

The new tag, e.g. <photo>, may be introduced in to the system by means of a plug-in. Thus, when a financial provider such as Visa decides to introduce photo information for future transactions, a new plug-in 222p may be added to provide this functionality. Once inserted the new plug-in 222p may inform the core switching engine 202 (and any other entity) of its existence. Each entity may then make any necessary adjustments, if any, to accommodate this new functionality. Since in embodiments the entities are pre-configured to use an extensible messaging format such as ASN.1 BER then the adjustments required may be minimal, and in some embodiments no changes are required.

Photo information (for comparison with stored photo information) may be generated at a point of sale, for example by scanning or otherwise reading a photo ID of a purchaser, or by taking a photo of the purchaser at the point of sale. This photo information may be encoded using the ASN.1 BER protocol discussed above.

In another embodiment fingerprint information may be added to the message format by means of a <fingerprint> field. The fingerprint information may be obtained at the point of sale, and subsequently encoded using ASN.1 BER.

Similar to the photo embodiment discussed above, the fingerprint functionality may be provided by means of a new plug-in 222p. Fingerprint information may be stored in a database accessible by the financial provider 210, and can be cross-checked with fingerprint information generated at end point 108 (e.g. POS or ATM) by means of a fingerprint scanner.

It will of course be understood that the photograph and fingerprint examples given above are by way of example only, and that the concept can be extended to include any type of new field. Whatever the embodiment, it will be appreciated that the system is configured in such a manner that further tags can be introduced, and/or old tags which are no longer required can be removed, without any major changes to the system structure. That is the messaging format is flexible to account for dynamic requirements within the system.

An embodiment will now be described in more detail with respect to the architecture of FIG. 2. When a transaction takes place at a service endpoint terminal 108 then information regarding that transaction needs to be sent in one or more messages to the endpoint processor 210, such as the Visa or MasterCard financial providers. As discussed above, the message comprises a message header and a message body. The message header comprises the endpoint address (e.g. the address of financial provider 210), or at least sufficient information enabling the message to reach the financial provider 210. Each entity between the endpoint terminal 108 and financial provider 210 is capable of reading the message header such that it knows to which entity to forward the message.

The message body comprises information about the transaction. For example it may identify a vendor, a price value associated with the transaction, an identity of the person requesting the transaction etc. As discussed above this information may be included in the message in the form of tags. This information is routed through the system to the financial provider 210 via financial switching engine 202. The financial provider 210 determines whether to enable the transaction using the information provided in the message body. This may comprise comparing information in the message body with information stored in one or more databases.

By way of example only, a card payment made at a shop may be considered. At the time of payment a user inserts their payment card into a machine such as a POS device 108. The user may be required to enter a pin number. The purchasing request ultimately needs to be sent to financial provider 210. Accordingly a message is generated having in its header address information enabling the message to be forwarded to the financial provider 210 via message filters 208d and 208c, financial switching engine 202, and message filter 208a. The message body comprises tags including information such as the cost of the purchase, and security information such as the pin number entered by the user, and one or more of the tags also has information to assist or cause the financial switching engine to switch the message correctly. The message then passes through message filters 208d and 208c towards financial switching engine 202. The switching engine 202 examines the message and determines that it is a request for a credit or debit card transaction and determines to which provider the request is to be sent. This step involves examining the tags that contain the information for facilitating the switching operation. The message is then forwarded to the appropriate financial provider 210. The financial provider 210 can then compare the information in the message body with information in a database of the financial provider (or a database accessible thereto) and determine whether to enable the transaction. Alternatively this comparison step can be conducted at the switching engine 202, or any other entity. A message can then be returned through the system to the POS device 108 indicating whether or not the transaction has been authorised.

Accordingly embodiments enable new requirements to be added to the messaging structure at any time, by virtue of the extensible nature of the messaging format.

It will of course be understood that the above embodiment relating to fingerprint and photograph functionality is by way of example only, and that information of any type can be added to or removed from the message format.

In the main, embodiments have been described where information is sent from the end point terminals to the 108 to the financial provider 210. It will of course be understood that information in a message format of the type described may also be sent in the reverse direction i.e. from financial provider 210 to financial switching engine 202 to end-point terminals 108.

The message format may also contain an element or a prompt which signals or declares to a receiver of the message that it contains one or more tags and that these tags need to be read and/or acted upon. The prompt may also identify particular tags from amongst a plurality of tags that need to be read and/or acted upon.

The messaging format is configured to meet all security and industry acceptance standards, and can be used within existing physical frameworks. The messaging format is also configured to operate in a fast manner and allow for high volumes, and is structured to not include significant overhead amounts which could negatively impact performance.

The described messaging format and system are flexible and scalable to account for changing requirements over time, with plugins being able to be developed and replaced by third parties. It provides multiple interfaces to access and manipulate data, e.g. SOAP, REST and/or ASN.1; and allows multiple script languages, including LUA.

It will be understood that, whilst having utility in financial transactions, the flexible messaging format can be extended to include other types of information, for example the photo and fingerprint information described above. Likewise, the financial switching engine, or indeed the system as a whole, is capable of handling information in addition to financial information. Therefore the flexible message format and the financial switching engine and system may be considered “universal” in that they are capable of handling any type of electronic message.

In embodiments any kind of data can be added to the flexible messaging format, and at any level. That is the flexible messaging format supports hierarchies. The flexible messaging format also enables “typing”, whereby the type of data included in or added to the message format can be defined. A “name” or “identifier” can also be added to each piece of content in the message. Accordingly the content can be dynamically accessed to find the correct routing path, to determine a message type, to carry out “multi-leg” transactions and to manipulate the message before processing internally or externally.

The combination of a flexible message format, flexible data storage and dynamic routing based on a script language may enable the introduction of new message types, routing rules and message content in to the system

The central operating system and plugin approach, as discussed above, enables a distribution of functionalities. The operating system can handle, for example, message delivery, multi-threading, plugin handling, a database abstraction layer, memory management, and performance controls. The plugins can, for example, implement business logic, and also have the ability to be chained to other plugins. Furthermore, the system may readily be implemented as a cloud based system.

Embodiments are not limited to any particular type of operating system. The operating system can for example be Linux, Windows etc. Whichever operating system is used, it can in embodiments abstract functionalities to the plugins, such as business logic.

It will be appreciated that the above embodiments have been described by way of example only. Other variations may become apparent to the skilled person given the disclosure herein. The scope of the disclosure is not limited by the described embodiments, but only by the accompanying claims.

1. A method comprising:
communicating at least one message in a financial transaction system comprising at least one end-user device, at least one financial-provider entity, and a financial switching engine located between said at least one financial-provider entity and said at least one end-user device, said financial switching engine arranged to perform a switching operation to switch the message between said at least one end-user device and said at least one financial provider entity;
wherein said message is for facilitating a financial transaction in said financial transaction system, and wherein said at least one message is adapted to be of an extensible format and configured to comprise a plurality of tags, wherein said tags comprise information facilitating said switching operation and additional operator-defined content;
and wherein said method comprises processing said information at at least one of said end-user device, said financial-provider entity and said financial switching engine for processing of said financial transaction.

2. A method as set forth claim 1, wherein
said method comprises configuring at least one of said financial-provider entity, said at least one end-user device, and said financial switching engine to define said operator-defined content.

3. A method as set forth in claim 1, wherein said financial transaction system comprises at least one plug-in.

4. A method as set forth in claim 3, wherein said method comprises attaching said plug-in to said system.

5. (canceled)

6. A method as set forth in claim 1, wherein one or more of said plurality of tags contain information for enabling said switching operation, and one or more other tags of said plurality of tags comprise said operator-defined content.

7. A method as set forth in claim 1, wherein said information in each of said tags comprises at least one of: security information; monetary value information; end-user identity information; fingerprint information; photograph information; and location information.

8. A method as set forth in claim 1, wherein said at least one message comprises a header and a message body, said plurality of tags being comprised in said message body.

9. (canceled)

10. A method as set forth in claim 1, wherein said operator-defined content provides functionality of a type not previously utilized in said system.

11. A method as set forth in claim 1, wherein said end-user device comprises at least one of a point-of-sales terminal and an automatic teller machine.

12-13. (canceled)

14. A non-transitory computer readable memory having stored thereon a computer program comprising computer executable instructions which when run on one or more processors perform the method of claim 1.

15. A system comprising:
at least one end-user device;
at least one financial-provider entity;
a financial switching engine located between said at least one financial-provider entity and said at least one end-user device; said financial switching engine arranged to perform a switching operation to switch the message between said at least one end-user device and said at least one financial provider entity;
wherein said at least one end-user device, said at least one-financial provider entity and said financial switching engine are configured to communicate at least one message for facilitating a financial transaction in said financial transaction system, wherein said at least one message is adapted to be of an extensible format and configured to comprise a plurality of tags, wherein said tags comprise information facilitating said switching operation and additional operator-defined content;
and wherein at least one of said end-user device, said financial-provider entity and said financial switching engine is configured to process said information in said plurality of tags for processing of said financial transaction.

16. A system as set forth in claim 11, wherein at least one of said financial-provider entity, said at least one end-user device, and said financial switching engine is configured to define said operator-defined content.

17. A system as set forth in claim 11, wherein said financial transaction system comprises at least one plug-in.

18. A system as set forth in claim 13, wherein an operator of said plug-in is configured to define said operator-defined content.

19. A system as set forth in claim 11, wherein one or more of said plurality of tags contain information for enabling said switching operation, and one or more other tags of said plurality of tags comprise said operator-defined content.

20. A system as set forth in claim 11, wherein said information in each of said tags comprises one or more of: security information; monetary value information; end-user identity information; fingerprint information; photograph information; and location information.

21. A system as set forth in claim 11, wherein said at least one message comprises a header and a message body, said plurality of tags being comprised in said message body.

22. A system as set forth in claim 11, wherein said system is configured to establish a private network.

23. A system as set forth in claim 11, wherein said operator-defined content provides functionality of a type not previously utilized in said system.

24-25. (canceled)

26. A system as set forth in claim 11, wherein said additional operator-defined content is used for a purpose other than said switching operation.
